(19) United States
(12) Patent Application Publication
(10) Pub. No.: US 2026/0336636 A1
(43) Pub. Date: Oct. 29, 2026

(54) SYSTEM AND METHOD FOR SAFE LEARNING-BASED MODEL PREDICTIVE CONTROL OF AUTONOMOUS VEHICLES

(71) Applicant: Gatik Al Inc., Mountain View, CA (US)

(72) Inventors: Vahid Azimi, Mountain View, CA (US); Ehsan Sabouni, Mountain View, CA (US); Parsa Taleb, Mountain View, CA (US); Arjun Narang, Palo Alto, CA (US); Gautam Narang, Palo Alto, CA (US); Apeksha Kumavat, Palo Alto, CA (US)

(73) Assignee: Gatik Al Inc., Mountain View, CA (US)

(21) Appl. No.: 19/661,292

(22) Filed: Apr. 28, 2026

Related U.S. Application Data
(60) Provisional application No. 63/796,182, filed on Apr. 28, 2025.

(51) Int. Cl. B60W 50/00; B60W 60/00; G05B 13/02; G05B 13/04

(52) U.S. Cl. CPC B60W 50/0097; B60W 60/001; G05B 13/0265; G05B 13/048; B60W 2530/16

(57) ABSTRACT

The system can include: a vehicle computing system, a vehicle platform; and/or any other suitable elements. The vehicle computing system can include and/or implement a set of navigation modules, a controller system, and/or any other suitable system components. The set of navigation modules can include a localization module; an objective generator; and a mapping module. The controller system can include a set of controllers (e.g., model predictive controllers), a safety function generator, a mismatch prediction model, a vehicle dynamics model, and/or any other suitable elements. In variants, the set of controllers can include a longitudinal controller and a lateral controller. However, the system can additionally or alternatively include any other suitable set of components. The system functions to dynamically control an autonomous vehicle to follow an objective.

### CROSS-REFERENCE TO RELATED APPLICATIONS

This application claims the benefit of U.S. Provisional Application number 63/796,182 filed 28-Apr.-2025, which is incorporated herein in its entirety by this reference.

### TECHNICAL FIELD

This invention relates generally to the vehicle controls field, and more specifically to a new and useful error tolerant control system and/or method in the vehicle controls field.

### BRIEF DESCRIPTION OF THE FIGURES

FIG. 1 is a schematic representation of a variant of the system.

FIG. 2 is a schematic representation of a variant of the method.

FIG. 3A-3B are schematic representations of variants of training the mismatch prediction model and predicting mismatch.

FIG. 4 is an illustrative example of a variant of mismatch prediction model training dataset determination.

FIG. 5 is a schematic representation of a variant of generating a set of constraints.

FIG. 6 is a schematic representation of a variant of predicting a vehicle command.

FIG. 7 is a schematic representation of a variant of the system.

FIG. 8 is an illustrative example of a variant of the system.

FIG. 9 is an illustrative example of a variant of determining a mismatch prediction model and predicting mismatch.

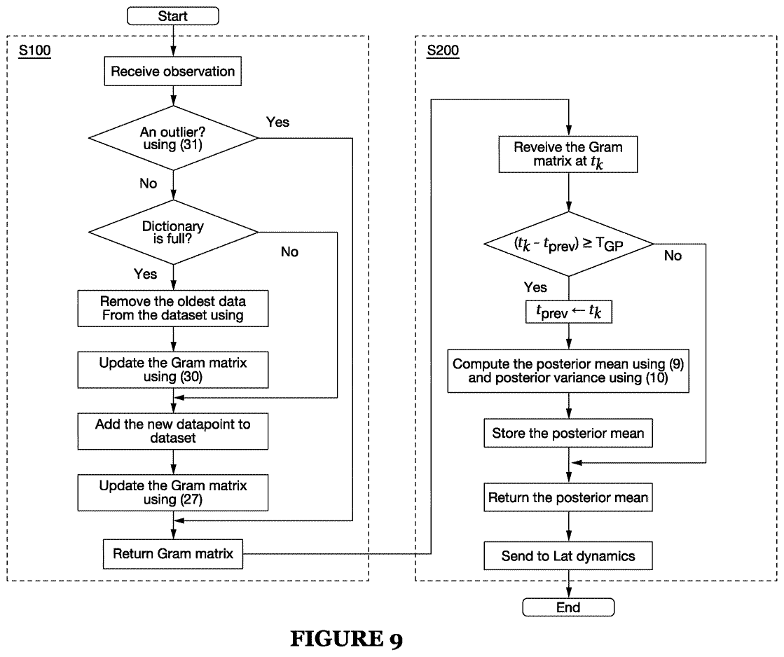

FIG. 10A-10B are a schematic representation of coupling signals across timesteps.

FIG. 11 is a schematic representation of a variant of the set of MPC controllers.

FIG. 12 is a schematic representation of a variant of the safety function generator during vehicle control.

### DETAILED DESCRIPTION

The following description of the embodiments of the invention is not intended to limit the invention to these embodiments, but rather to enable any person skilled in the art to make and use this invention.

### 1. Overview

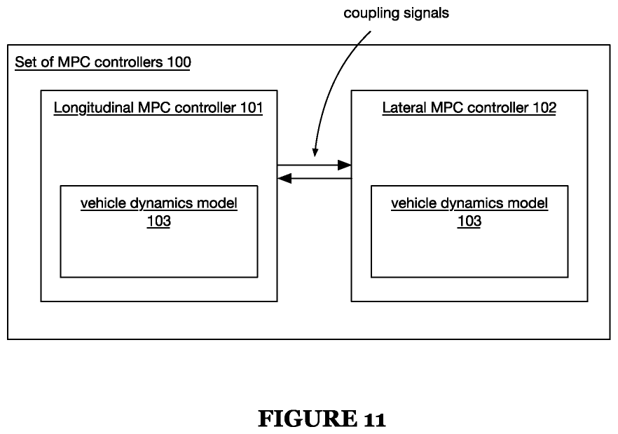

The system can include: a vehicle computing system 20, a vehicle platform 30; and/or any other suitable elements. The vehicle computing system 20 can include and/or implement a set of navigation modules 21, a controller system 22, and/or any other suitable system components. The set of navigation modules 21 can include a localization module 200; an objective generator 300; and a mapping module 400. The controller system 22 can include a set of controllers 100 (e.g., model predictive controllers), a safety function generator 600, a mismatch prediction model 700, a vehicle dynamics model 103, and/or any other suitable elements. In variants, the set of controllers can include a longitudinal controller 101 and a lateral controller 102 (e.g., example shown in FIG. 11). However, the system can additionally or alternatively include any other suitable set of components. The system functions to dynamically control an autonomous vehicle to follow an objective (e.g., a planned trajectory, etc.).

### 1.1 Illustrative Examples

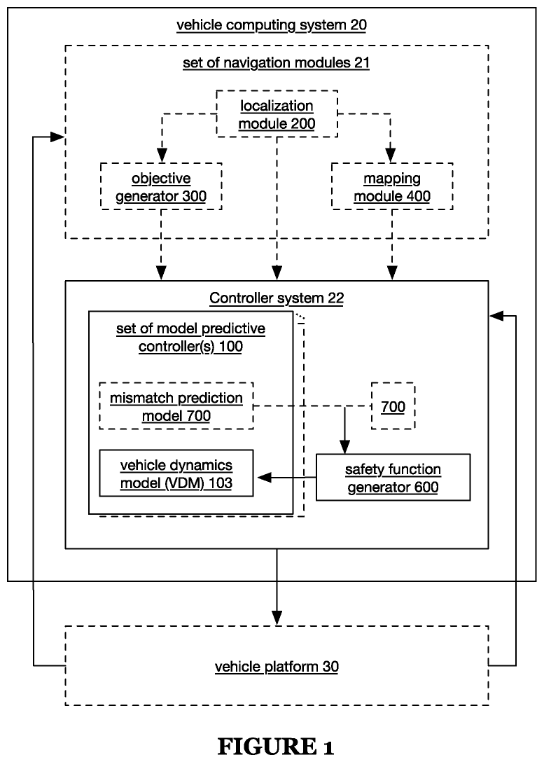

In an illustrative example (e.g., example shown in FIG. 1), variants of the system can include a localization module which can use sensor observations to estimate a state of a vehicle (e.g., a truck). A set of model predictive control (MPC) controllers can leverage the estimated state to predict a set of vehicle commands (e.g., steering commands) given a vehicle objective (e.g., a trajectory). The vehicle commands can be used to determine vehicle controls (e.g., used as vehicle controls, used upstream of vehicle control determination, etc.) implemented using a drive-by-wire system. The MPC controllers can leverage information from a set of navigation modules 21, which can include a localization module (e.g., vehicle kinematics, etc.), an objective generator (e.g., a trajectory objective, etc.), and/or a mapping module (e.g., environmental parameters, etc.). The MPC controllers can additionally receive information from a tire stiffness estimation module (e.g., tire stiffness parameters, etc.) and/or any other suitable modules. The MPC controller(s) can use a vehicle dynamics model (e.g., a bicycle model) as part of the optimization, which can leverage estimated and/or observed parameters to model and/or predict vehicle kinematic behavior (e.g., to determine a future vehicle state, etc.). However, due to the relative simplicity of the vehicle dynamics model, a trained mismatch prediction model can be used to predict the difference between predicted vehicle behavior (e.g., from the vehicle dynamics model) and actual vehicle behavior (e.g., determined from observations by the localization module) and correct the predictions made by the vehicle dynamics model. Furthermore, the MPC controller can operate subject to a set of constraints limiting deviation from the objective (e.g., the objective trajectory). In this illustrative example, when a new obstacle is detected in the scene, a set of constraints (e.g., a control barrier function) applied to a controller can be re-determined based on the identified obstacle and a predicted mismatch value determined by the mismatch prediction model. The control barrier function can utilize a multi-ordered approach, whereby multiple orders (e.g., 4) of control barrier functions are determined and represent higher-order derivatives of constraints with respect to time.

The trained mismatch prediction model can be dynamically updated during vehicle operation using pairs of predicted versus estimated vehicle state at a subset of recent timesteps (e.g., by training the mismatch prediction model on a filtered subset of predicted vs estimated vehicle state pairs, etc.).

### 2. Benefits

Variations of the technology can afford several benefits and/or advantages.

First, variants of the technology can account for several real-world parameters which may be challenging to model directly (e.g., tire-road interactions, mass distribution changes, aerodynamic forces, actuator dynamics, sensor calibration issues, etc.). By using a single mismatch prediction model (e.g., a trained Gaussian Process), such real-world parameters can be effectively accounted for in both constraint generation and model predictive control (MPC). Such real-world parameters can effectively be consolidated into a single “mismatch” value which reflects the vehicle's observed deviation from a vehicle kinematics prediction (e.g., by a relatively simple bicycle model). The simplicity of both the bicycle model and the GP-based corrections to the bicycle model enable sophisticated and resource-heavy optimization methods to be performed on the vehicle. Furthermore, the prediction of mismatch enables the system to predict actual vehicle behavior when performing optimization-based model predictive control, resulting in more optimal decision-making. Because the mismatch prediction model can continuously refine its mismatch estimate based on observed system behavior, the accuracy of the predictive model used by the MPC can improve progressively over the course of operation, leading to control actions that are based on an increasingly faithful representation of the vehicle's true dynamics.

Second, variants of the technology can simplify the generation and application of constraints which account for multitude of complex factors. Instead of each constraint being a function of many (e.g., thousands) of variables, a mismatch value can simplify the complexity to enable the rapid re-determination of constraints over time so the vehicle can dynamically adjust its conservatism to a given context.

Third, variants of the technology can better model and correct the modeled kinematics of a large, complex vehicle (e.g., such as a truck). Trucks often have many relatively distant components connected non-rigidly, and the highly variable payloads and load distributions in a truck can make modeling truck behavior complex and difficult. The implementation of a Gaussian Process which is trained in near-real time to predict mismatch between behavior predicted by a vehicle dynamics model and actual truck behavior enables the system to learn the nuances of its present kinematics behavior, even multiple times in the same trip. This implementation can improve the safety and the reliability of autonomous vehicle controls implemented by the system.

Fourth, variants of the technology can enable improved safety constraint enforcement through model mismatch-aware control barrier functions (CBFs). In variants employing CBFs, the CBF constraints can be derived using the learned dynamics that incorporate the mismatch prediction model's point estimates, rather than using nominal dynamics alone. The resulting model mismatch-aware CBF can provide more robust safety guarantees than a nominal CBF (e.g., because a nominal CBF may fail to prevent the system from entering unsafe states when actual dynamics differ from the nominal model); can be more adaptable to unknown dynamics (e.g., because the CBF dynamically adjusts as the mismatch prediction model refines its posterior estimate of unmodeled dynamics over time); and can reduce conservatism (e.g., by integrating uncertainty estimates to allow for more aggressive control strategies, thereby improving overall system performance), and/or can provide any other suitable advantage(s).

Fifth, variants of the technology can achieve high-fidelity control performance without a corresponding increase in computational burden. By formulating safety sets as convex polygons that dynamically adapt to changes in path boundaries and obstacles, and by leveraging the mismatch prediction model's compact representation of unmodeled dynamics, the system can generate and enforce safety constraints in real-time at the vehicle's control frequency. This can enable the system to maintain low-latency control loops suitable for real-time autonomous driving (e.g., because the mismatch prediction model produces a low-dimensional correction rather than requiring a high-fidelity physics simulation at each control step); can allow the system to scale to complex driving scenarios without requiring proportional increases in computing resources (e.g., because the convex polygon-based safety set computation avoids the combinatorial complexity of evaluating arbitrary non-convex constraint regions); and can facilitate deployment on vehicle-mounted computing hardware with limited processing capacity, and/or can provide any other suitable advantage(s).

However, variations of the technology can additionally or alternately provide any other suitable benefits and/or advantages.

### 3. System

The system 100, an example of which is shown in FIG. 1, can include: a vehicle computing system 20, a vehicle platform 30; and/or any other suitable elements. The system functions to dynamically control an autonomous vehicle to follow an objective. Additionally or alternatively, the system can function to facilitate autonomous vehicle control.

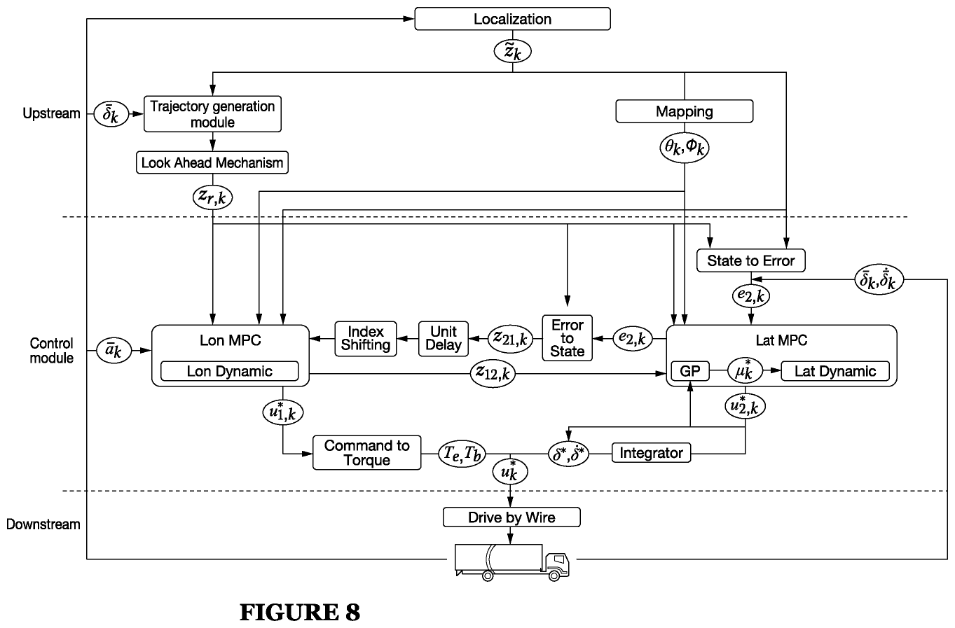

The vehicle computing system 20 can include and/or implement a set of navigation modules 21, a controller system 22, and/or any other suitable system components. The set of navigation modules 21 can include a localization module 200; an objective generator 300; and a mapping module 400. The controller system 22 can include a set of controllers 100 (e.g., model predictive controllers [MPC], etc.), a safety function generator 600, a mismatch prediction model 700, a vehicle dynamics model (VDM) 103, and/or any other suitable elements. In variants, the set of controllers can include a longitudinal controller 101 and a lateral controller 102. The system can include any other suitable components. For instance, the system can include modules (e.g., MPCs, navigation modules, etc.) that operate substantially independently, at individual frequencies. The modules which use outputs of other modules can use the most recently-determined values (e.g., from a current timestep or a prior timestep, etc.). The modules can alternatively operate synchronously and/or according to any other operational pattern. In a variant, the system can be the system shown in FIG. 8.

The modules which use the outputs of other modules can use the most recently-determined values. The modules can alternatively operate synchronously or according to any other suitable temporal pattern(s) or relationship(s).

The system can implement any of the aforementioned modules (e.g., the set of navigation modules, generators, controllers, etc.) using local and/or remote computing resources. The vehicle computing system can include one or more: CPUs, GPUs, custom FPGA/ASICS, microprocessors, servers, cloud computing, and/or any other suitable components. The computing system can be local, remote, distributed, or otherwise arranged relative to any other system or module.

The modules of the system can perform their respective functions in real time (e.g., responsive to a request), iteratively, concurrently, synchronously, asynchronously, periodically, and/or at any other suitable timing/frequency. The modules of the system can perform their respective functions automatically, manually, semi-automatically, and/or otherwise performed.

The system can include embodiments with combinations and permutations of various system components and module processes. One or more instances of the module processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the system and/or method can be used with, in addition to, in lieu of, or otherwise integrated with all or a portion of the systems and/or methods disclosed in the applications mentioned above, each of which are incorporated in their entirety by this reference.

Models (e.g., integrated in the system and/or executed by modules, generators, and/or controllers of the system) can include classical or traditional approaches, machine learning approaches (e.g., online learning), and/or be otherwise configured. The models can include regression (e.g., linear regression, non-linear regression, logistic regression, etc.), decision tree, LSA, clustering, association rules, dimensionality reduction (e.g., PCA, t-SNE, LDA, etc.), neural networks (e.g., CNN, DNN, CAN, LSTM, RNN, encoders, decoders, deep learning models, transformers, etc.), ensemble methods, optimization methods, classification, rules, heuristics, equations (e.g., weighted equations, etc.), selection (e.g., from a library), regularization methods (e.g., ridge regression), Bayesian methods (e.g., Naive Bayes, Markov), instance-based methods (e.g., nearest neighbor), kernel methods, support vectors (e.g., SVM, SVC, etc.), statistical methods (e.g., probability, Gaussian Processes), comparison methods (e.g., matching, distance metrics, thresholds, etc.), deterministics, genetic programs, and/or any other suitable model. The models can include (e.g., be constructed using) a set of input layers, output layers, and hidden layers (e.g., connected in series, such as in a feed forward network; connected with a feedback loop between the output and the input, such as in a recurrent neural network; etc. ; wherein the layer weights and/or connections can be learned through training); a set of connected convolution layers (e.g., in a CNN); a set of self-attention layers; and/or have any other suitable architecture. The models can include models executed by the localization module, mapping module, objective generator, safety function generator, error region determination module, constraint generator, MPC controllers and/or any other suitable model-executing module. The models can include the mismatch prediction model, the vehicle dynamics model, and/or any other suitable model.

Models can be trained, learned, fit, predetermined, and/or can be otherwise determined. The models can be trained or learned using: supervised learning, unsupervised learning, self-supervised learning, semi-supervised learning (e.g., positive-unlabeled learning), reinforcement learning, transfer learning, Bayesian optimization, fitting, interpolation and/or approximation (e.g., using gaussian processes), backpropagation, and/or otherwise generated. The models can be learned or trained on: labeled data (e.g., data labeled with the target label), unlabeled data, positive training sets (e.g., a set of data with true positive labels, negative training sets (e.g., a set of data with true negative labels), and/or any other suitable set of data.

Any model can optionally be validated, verified, reinforced, calibrated, or otherwise updated based on newly received, up-to-date measurements; past measurements recorded during the operating session; historic measurements recorded during past operating sessions; or be updated based on any other suitable data.

Any model can optionally be run or updated: once; at a predetermined frequency; every time the method is performed; every time an unanticipated measurement value is received; or at any other suitable frequency. Any model can optionally be run or updated: in response to determination of an actual result differing from an expected result; or at any other suitable frequency. Any model can optionally be run or updated concurrently with one or more other models, serially, at varying frequencies, or at any other suitable time.

However, models can be otherwise configured.

### 3.1 Navigation

The set of navigation modules 21 function to determine vehicle context and objectives. Additionally, the set of navigation modules preferably performs S300, but can additionally and/or alternatively perform other suitable method step(s). The set of navigation modules 21 can include a localization module 200; an objective generator 300; and a mapping module 400.

The set of navigation modules can receive input including measurements (e.g., camera measurements, lidar measurements, GPS coordinates, GNSS measurements, kinematic sensor measurements), time history of object tracks, and/or any other inputs. Based on the set of inputs, the set of navigation modules can output a set of objectives, environmental parameters, an environmental representation, updated object tracks, and/or any other outputs. In a variant, the navigation modules (e.g., the localization module 200, objective generator 300, mapping module 400, etc.) can be the “navigation modules” (e.g., the “localization module 200,” “objective generator 300,” and “mapping module 400,” etc.) described in U.S. Application Number Ser. No. 19/340,391, filed 25-Sep.-2025, which is incorporated herein in its entirety by this reference.

In variants, the set of navigation modules 21 can include a localization module 200; an objective generator 300; and a mapping module 400.

The localization module 200 functions to estimate a vehicle state estimate. The localization module is preferably implemented by the vehicle computing system 20, but can alternatively be implemented by another suitable system component. The localization module can receive a set of inputs which can include: a set of sensor measurements (e.g., visual measurements, IMU measurements, etc.), a set of prior observed kinematic information, a set of prior planned states, and/or any other suitable information. The localization module can output an estimated vehicle state based on the set of inputs. In a first variant, the vehicle state can be an observed state (e.g., from measurements). In a first example of this variant, the input to the localization module can be the wheel odometry from rotary encoders attached to the truck wheels. In a second example of this variant, the input to the localization module can be the wheel odometry from rotary encoders attached to the truck wheels, and/or the observed state can be determined by fusing measurements from multiple sensors (e.g., GPS/GNSS, LiDAR, cameras, wheel odometry, etc.). In a second variant, the estimated vehicle state can be a modeled state (e.g., using a vehicle dynamics model such as a bicycle model of the vehicle, etc.). In an example of the second variant, the modeled state can be determined by learning a mismatch between a predicted state and an actual state, then using a mismatch prediction model to augment a modeled state using a predicted mismatch. In a third variant, the estimated vehicle state can be a future state from previous timestep or method iteration (e.g., inferred or predicted by linear regression between update cycles). The estimated vehicle state can additionally and/or alternatively be determined through any other method. The estimated vehicle state can include vehicle kinematics (e.g., position, velocity, acceleration, jerk, rotation, angular velocity, angular acceleration, angular jerk in any suitable dimension, etc.). The estimated vehicle state can include components of error (e.g., divergence from an objective). In an example, the error can refer to divergence from an objective path (e.g., a trajectory). The error can include lateral position error, rate of change of lateral position error, heading error, rate of change of heading error, steering angle error, rate of change of steering angle error, and/or parameters indicating any other suitable type of error. The estimated vehicle state can be in a world reference frame (e.g., heading angle, etc.), a vehicle reference frame (e.g., yaw angle, etc.), and/or any other suitable reference frame. The estimated vehicle state can be absolute and/or can represent a change in kinematics from a previous timestep.

However, the localization module may be otherwise configured.

The objective generator 300 (e.g., equivalently referred to as a “planner” or “planning module”) functions to determine an objective for the autonomous vehicle. The objective preferably includes a trajectory but can additionally or alternatively include other suitable objectives such as a target speed, a path, route, a set of waypoints, an error tolerance, a bounded range, and/or any other type of objective. In a first set of examples, the objective generator can include a set of reference path coordinates, a reference heading angle, a reference longitudinal position and velocity, and/or a reference path curvature. In a second example, an objective can be an “error state” (e.g., a difference between a current [estimated] state and a vehicle trajectory). In this example, estimated state can be converted into an error state, which is input into an MPC controller (e.g., the lateral MPC controller, etc.).

The objective generator can include a target position, target velocity, target acceleration, target jerk, and/or any other suitable information. In a first variant, an objective is a trajectory defined from a position of the vehicle (e.g., starting at the autonomous vehicle). In a second variant, an objective is a trajectory and/or reference path that exists in world space (e.g., where the autonomous vehicle, in variants, may or may not be on the path, etc.). The vehicle trajectory can include suitable attributes of a vehicle motion plan, including position, rotation (and/or first and second derivatives thereof, etc.), and/or any other attributes. The objective generator can additionally generate vehicle trajectory attributes that can change over a future set of timesteps (e.g., over a planning horizon), but can alternatively generate vehicle trajectory attributes that do not change over a future set of timesteps. The planning horizon (NP) can be 2 seconds, 4 seconds, 6 seconds, 8 seconds, 10 seconds, 15 seconds, can be within an open or closed range bounded by the aforementioned values, and/or can be any other suitable planning horizon. The planning horizon can have the same or different length as the control horizon.

The objective generator can perform trajectory generation based on a determined route of the vehicle, based on a received trajectory, based on a decided action of the vehicle, based on a set of predetermined operation parameters (e.g., max speed, max jerk, etc.), and/or any other suitable input information. In variants, the objective generator preferably uses an estimated vehicle state determined at the localization module, a route and/or goal (e.g., a high-level goal destination, etc.), and/or any other suitable information, but can additionally and/or alternatively use other information. In variants, the objective generator can additionally/alternatively perform obstacle detection and avoidance. In an example, when the objective generator detects an obstacle, the safety function generator generates a new set of error regions based on attributes of the obstacle (e.g., position, shape, size, etc.). In variants, the objective generator can leverage an action model (e.g., determining a vehicle action, etc.), a trajectory model (e.g., determining a vehicle trajectory, etc.), and/or any other suitable models. The models can be trained models, non-trained models, and/or any other suitable type of model. The models can be specific to a current context, specific to an action type, and/or otherwise specific or non-specific.

However, the objective generator 300 may be otherwise configured.

The mapping module 400 functions to determine environmental parameters and optionally an environmental representation (e.g., a virtual model) of the environment around the vehicle. The mapping module can receive inputs including sensor information/measurements related to: vehicle position, longitudinal velocity/acceleration, lateral velocity, heading rate, and/or any other vehicle measurements. Based on the inputs, the mapping module can output environmental parameters (e.g., to be used by the controller). In an example, the mapping module fuses sensor information into an environmental representation which can include road boundaries, obstacles, and/or any other suitable information. In this example, the environmental parameters can be extracted and/or otherwise determined from the environmental representation.

The mapping module preferably uses sensor information (e.g., sensor measurements captured by a vehicle sensor suite and/or data calculated from sensor measurements, etc.) to determine environmental parameters, but can alternatively use information extracted from a map (e.g., based on the vehicle location), context-specific information, and/or any other suitable information about the environment. In an example, the mapping module fuses sensor measurements from a vehicle sensor suite into an environmental representation which can include road boundaries, obstacles, and/or any other suitable information.

The environmental parameters determined by the mapping module can include an angle of inclination (θ), a road banking angle (φ), aerodynamic drag forces (Fₐₑᵣₒ), rolling resistance (Rₓ), road friction coefficients, temperature, road texture, road curvature, road width, superelevation and/or other environmental parameters.

The mapping module can additionally detect obstacles in the environment (e.g., triggering redetermination of the safety function, etc.). In an example, when a new object is detected in the environment, S400 is triggered to update the control barrier function (CBF) constraining state prediction (e.g., performed by a lateral MPC).

The mapping module can generate an environmental representation that can include representations of obstacles (e.g., semantic classification, location, dimensions, etc.), a road representation, and/or other suitable information. In an example, the mapping module generates the environmental representation using methods described in U.S. Application Ser. No. 17/116,810, filed 09-Dec.-2020, which is incorporated herein in its entirety by this reference.

However, the mapping module 400 may be otherwise configured.

However, the set of navigation modules 21 may be otherwise configured.

### 3.2 Controls

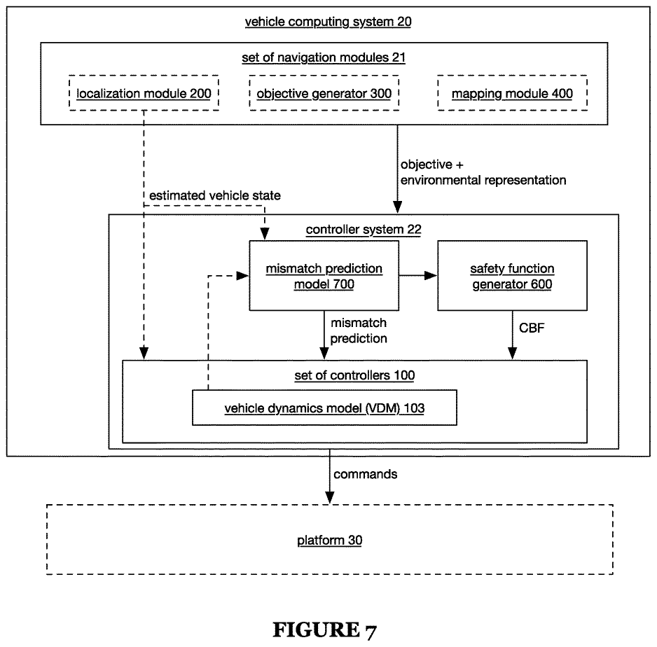

The controller system 22 functions to determine vehicle commands based on vehicle context and an objective (e.g., example shown in FIG. 7). The controller system 22 can include a set of Model Predictive Control (MPC) controllers 100, a safety function generator 600, a mismatch prediction model 700, a vehicle dynamics model 103, and/or any other suitable elements. Additionally, the controller system preferably performs S200, S400, S500, and/or any other suitable processes, but can additionally and/or alternatively perform other processes. In a variant, the controller system 22 (e.g., the set of Model Predictive Control (MPC) controllers 100, the safety function generator 600, the mismatch prediction model 700, the vehicle dynamics model 103, etc.) can be the “controller system 22” (e.g., the “set of Model Predictive Control (MPC) controllers 100”, “safety function generator 600,” “mismatch prediction model 700,” “vehicle dynamics model 103,” etc.) described in U.S. Application Number Ser. No. 19/340,391, filed 25-Sep.-2025, which is incorporated herein in its entirety by this reference.

The controller system can receive inputs, from the set of navigation modules, including: environmental parameters, objective, and/or any other inputs. Based on the inputs, the controller system can output: a set of vehicle commands, a predicted mismatch, a predicted vehicle kinematics error, vehicle controls, and/or any other outputs for the drive-by-wire system.

The mismatch prediction model 700 functions to predict mismatch between predicted vehicle state (e.g., determined using a vehicle dynamics model) and estimated vehicle state (e.g., determined by the localization module).

The mismatch prediction model is preferably implemented by the vehicle computing system, but can alternatively be implemented by another suitable system component and/or any other system component. The mismatch prediction model can represent mismatch as a distribution (e.g., extracted from a GP, etc.), can alternatively be a single value, and/or any other representation. Additionally or alternatively, the mismatch prediction model can optionally determine uncertainty value associated with predictions (e.g., confidence intervals, etc.) and/or can determined any other suitable prediction(s). In an example, the mismatch prediction model outputs a point estimate (e.g., a mean prediction) and a covariance or uncertainty estimate, and/or any other estimates.

The mismatch prediction model preferably uses trained methods, but can alternatively use heuristics and/or other suitable methods. Examples of trained methods can include a Gaussian Process (GP), a weighted regression, reinforcement learning, a neural network (e.g., deep neural network, etc.), model reference adaptive control (MRAC), L1 adaptive control, and/or any other suitable methods. In a specific example, a gaussian process can be used due to its ability to capture complex, unknown dynamics directly from data. The gaussian process can predict both a mean mismatch and variance for a given set of inputs (e.g., vehicle state, etc.).

The mismatch prediction model can be dynamically updated (e.g., in S100), alternatively pretrained and static, and/or otherwise configured. In an example, the mismatch prediction model is recursively updated to de-weight the influence of an old training datapoint and incorporate the influence of a new training datapoint(s) without retraining the entire Gaussian Process from an initial condition. In variants, the mismatch prediction model can be updated at a predetermined interval, at a dynamically-determined interval, and/or responsive to a condition (e.g., detection of a new context, detection of a new obstacle, etc.). In a further variant, rather than updating a single model, the mismatch prediction model can select between a set of models based on context (e.g., selecting a model trained on a particular road type, payload configuration, driving scenario, etc.), and/or can otherwise be determined.

The mismatch prediction model can receive inputs including: estimated vehicle state (e.g., determined by the localization module, etc.), environmental parameters (e.g., banking angle of the road, etc.), objective information (e.g., a rate of change of a trajectory heading, etc.), and/or any other inputs.

The output of the mismatch prediction model (e.g., predicted mismatch), determined based on the set of inputs, can include: lateral position mismatch, rate of change of lateral position mismatch, heading mismatch, rate of change of heading mismatch, steering angle mismatch, rate of change of steering angle mismatch, and/or any other mismatch between the predicted vehicle state parameter value(s) and estimated/measured value(s). In an example, inputs to the mismatch prediction model can include error states, banking angle of the road, rate of change of the reference heading, longitudinal velocity, and/or other suitable information.

In a specific example using a Gaussian Process, the model outputs a GP point estimate (μ*_k) comprising a posterior mean for each mismatch output, computed from the Gram matrix and the GP feature vector at each timestep. In a specific example, The mismatch prediction model preferably updates its output at each control timestep, but can alternatively hold the most recently computed prediction if the update interval has not elapsed.

In a specific example, the output of the mismatch prediction model can be applied as an additive correction to the nominal predicted next state. In a variant, the mismatch prediction model can use a kernel-based similarity metric (e.g., a squared exponential kernel, etc.) to compute the GP posterior. In a variant, each output dimension of the mismatch prediction model can be learned as an independent Gaussian Process.

In a specific example, the mismatch prediction model can be applied primarily to the lateral component of the vehicle dynamics, because the discrepancy between the nominal model and actual behavior in the longitudinal component can be empirically negligible. In this example, the mismatch prediction model augments only the lateral dynamics used by the lateral MPC controller. However, the mismatch prediction model can alternatively be applied to the longitudinal component, to both components, and/or to any other suitable dynamics component(s).

However, the mismatch prediction model may be otherwise configured.

The vehicle dynamics model (VDM) 103 functions to model vehicle dynamics for a vehicle controller (e.g., for an controller, etc.).

The vehicle dynamics model is preferably a bicycle model, but can alternatively be a point-mass model, four-wheel model, articulated vehicle model, and/or any other vehicle model type. In an example, the vehicle dynamics model can be a bicycle model decomposed into longitudinal and lateral components, wherein the controller uses one of the two components. The use of a relatively simple vehicle dynamics model (e.g., a bicycle model, etc.) can enable efficient convergence on an optimal control solution by the controller(s), while unmodeled dynamics are accounted for by the mismatch prediction model rather than by increasing model complexity.

In a specific example, the longitudinal and lateral components of the vehicle dynamics model can be coupled through shared signals. In a specific example, the lateral-to-longitudinal coupling signals can include lateral velocity and heading rate (e.g., z₂₁=[\dot{y}, \dot{ψ}], etc.), and the longitudinal-to-lateral coupling signal can include longitudinal velocity (e.g., z₁₂=\dot{x}, etc.).

The vehicle dynamics model can use an estimated tire cornering stiffness (e.g., determined by the tire stiffness computation module, etc.), an estimated center of gravity, a known wheelbase, a known vehicle mass and/or moment, and/or any other suitable parameters. In a specific example, the vehicle dynamics model can use system parameters including vehicle mass (m), yaw moment of inertia (I_z), front and rear axle distances (l_f, l_r), wheel radius (r), gear force factor (G_f), and actuator time constants (τ₁, τ₂, T_d), and/or any other suitable parameters. The vehicle dynamics model base model parameters can be dynamically and/or adaptively updated, but can alternatively not be dynamically updated (e.g., held fixed within a particular time interval; with one or more model parameters held static/invariant).

In a variant, the vehicle dynamics model can incorporate a first-order linear actuator model for one or more actuators (e.g., steering motor, throttle, braking system, etc.) to account for actuator response lag. In this variant, actuator states (e.g., acceleration [a] for the longitudinal component; steering angle [δ] and steering rate [δ] for the lateral component; etc.) can be augmented into the vehicle state space, such that the augmented longitudinal state (e.g., augmented by the linear actuator model) is z₁=[x, \dot{x}, a] and the augmented lateral state is z₂=[y, \dot{y}, ψ, \dot{ψ}, δ, \dot{δ} ], and/or any other suitable augmented states.

In a variant, the lateral component of the vehicle dynamics model can be expressed in an error-based formulation, wherein the state variables represent lateral position error and orientation error relative to a reference path (e.g., e₂=[e_{γ}, ė_{γ}, e_{ψ}, ė_{ψ}, δ, \dot{δ} ] etc.) rather than absolute states. The error-based formulation can enable the controller to directly optimize over path-relative error states, and/or can otherwise be configured.

In a first variant, the vehicle dynamics model can be used by the controller to predict and evaluate potential future trajectories of the vehicle. In this variant, the vehicle dynamics model can perform naive prediction of vehicle state (e.g., without accounting for unmodeled dynamics), wherein the controller can optionally correct the naively-predicted future vehicle states using a predicted mismatch value determined by the mismatch prediction model. In a second variant, the vehicle dynamics model can be used by the localization module to determine a set of estimated vehicle state information (e.g., in cases where the measurement-based methods are not fast enough to provide vehicle state, etc.). In an example, the vehicle dynamics model can use the error equation shown in Equation 1 as follows to correct vehicle state, where ē represents predicted error state, μₖ* represents a mean prediction from the Gaussian process, and the matrix B_{d} defines how unmodeled dynamics determined from point estimates affect system states.

e_{2, k+1}=ē_{2, k+1}+B_{d}(μₖ*) Equation 1

In a third variant, the vehicle dynamics model can be used to generate training data for the mismatch prediction model, wherein predicted states from the vehicle dynamics model are compared against observed states from the localization module to determine mismatch values used as training targets.

However, the vehicle dynamics model may be otherwise configured.

The set of Model Predictive Control (MPC) controllers 100 functions to determine vehicle commands based on an estimated vehicle state.

Each MPC controller preferably includes and/or implements a model predictive control scheme(s), but can additionally and/or alternatively use other suitable control architectures. However, the set of MPC controllers can perform S500 and/or any other suitable processes.

In variants, model predictive control can include solving an optimization problem (optionally subject to a set of constraints) at each time step in order to predict vehicle commands. In variants, the optimization problem can minimize one or more objectives, including: a first objective of minimizing deviation from a reference trajectory (e.g., minimizing the difference between planned and reference states over the control horizon, etc.), a second objective of minimizing control effort (e.g., minimizing the difference between applied and reference control inputs over the control horizon, etc.), and/or any other suitable objectives. In a variant, both objectives can be combined into a single cost function weighted by positive definite state and input weight matrices (e.g., W₁, R₁ for the longitudinal MPC; W₂, R₂ for the lateral MPC; etc.).

In a first variant, the system can include a set of MPC controllers, which can predict vehicle commands. In an example of this variant, a single MPC controller (e.g., a longitudinal MPC controller, a lateral MPC controller, etc.) of a set of MPC controllers can use constraints generated by the safety function generator. In a specific example of this variant, the CBF constraints generated by the safety function generator can be applied to the lateral MPC only (e.g., not to the longitudinal MPC) and/or can alternatively be applied to the longitudinal only or both. In a second variant, the system can include a single MPC controller predicting both longitudinal and lateral vehicle commands and/or future states. However, MPC can be otherwise implemented.

The set of MPC controllers preferably uses linear model predictive control (LMPC), but can alternatively include nonlinear MPC, pure pursuit controllers, PID controllers, sliding mode control, backstepping controllers, fuzzy logic, robust control theory, and/or other suitable principles, methods or control techniques for vehicle controls determination.

The set of MPC controllers can use an Operator Splitting Quadratic Program (OSQP) solver, a quadratic programing Online Active Set Strategy (qpOASES), and/or any other suitable solver.

The set of MPC controllers can: integrate the CBF into the optimization process of optimization-based control determination, leverage the vehicle dynamics model to predict (e.g., naively, etc.) vehicle state, correct vehicle states, and/or can execute any other suitable processes for vehicle control.

In a variant, the set of MPC controllers can incorporate a most recent parameterized control barrier function (CBF) determined by the safety function generator into the optimization directly, such that the optimization can be subject to the CBF. The CBF can be dynamically-updated upon receipt from the safety function generator, but can alternatively not be dynamically-updated upon receipt from the safety function generator. In a variant, the CBF constraints and/or state constraints can be softened using one or more slack variables. In a specific example, the CBF constraints and/or state constraints can be softened using a first slack variable λ₁ for lateral error constraints and a second slack variable λ₂ for orientation error constraints. In this variant, the slack variables can be quadratically penalized by a large positive cost in the objective function and constrained to be non-negative, such that constraint softening is only invoked when necessary and is strongly discouraged by the cost, and/or can be otherwise configured.

In an example, the CBF can be based on a convex safety set in order to apply the CBF to a linear MPC within the set of MPC controllers. In this example, the convexity of the safety set for the set of MPC controllers can flow from convexity of a polygon in an N-dimensional error space, wherein the safety set is determined from the convex polygon.

In a variant, the set of MPC controllers can leverage the vehicle dynamics model to model vehicle state parameters (e.g., kinematic state, etc.) during optimization. The usage of a relatively simple vehicle dynamics model (e.g., a bicycle model, etc.) can enable efficient convergence on an optimal control solution. In this variant, the set of MPC controllers can optionally correct future vehicle states from a vehicle dynamics model using a predicted mismatch value determined by the mismatch prediction model.

The set of MPC controllers can ingest an estimated vehicle state, a time history of vehicle states, a set of vehicle parameters (e.g., a dynamically updated set of parameters, etc.), environmental parameters, a predicted mismatch value, and/or any other suitable information.

The set of MPC controllers can output a set of vehicle commands, future states (e.g., planned kinematic states), a predicted error (e.g., predicted lateral error, a predicted yaw error, etc.), and/or any other suitable information. The vehicle commands can be determined from the set of future states or can be independent from the set of future states, and/or otherwise determined.

However, the set of MPC controllers can be otherwise configured.

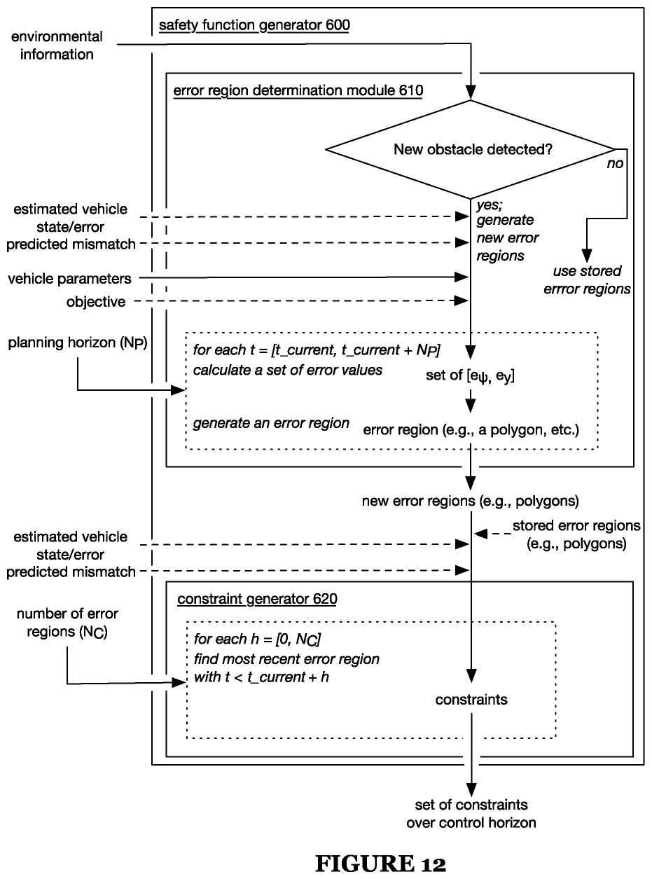

The safety function generator 600 functions to generate a control barrier function (CBF) for use by the MPC controller and execute Block S400. The safety function generator can include and/or implement a control barrier function that can constrain the determined output state or trajectory determined by the MPC. In a variant, the safety function generator can include an error region determination module 610 and a constraint generator 620 (e.g., example shown in FIG. 12).

In a first variant, the safety function generator is part of an MPC controller (e.g., the lateral MPC controller 102, etc.). In a second variant, the safety function generator is separate from the MPC controller. However, the safety function generator can be otherwise arranged.

The safety function generator can receive inputs (e.g., obstacle information path boundary information, vehicle bounding box size, error bounds, a prediction horizon, model mismatch estimates, a current vehicle state, etc.) and generate the CBF as an output. The safety function generator can use CBF (e.g., by the controller and/or set of MPCs thereof) to constrain the determined vehicle commands determined by the MPC controller. In a first variant, the control barrier function can be determined based on a set of polygons in an error space representing a “safety set” of error.

In a variant, the safety function generator's control barrier function can incorporate predicted model mismatch (e.g., determined by the mismatch prediction model, etc.).

The error region determination module 610 functions to determine the safety set as represented by polygons in error space. The error region determination module (alternatively referred to as a “polygon generator”) can perform S400 as triggered by detection of a new obstacle in the scene, and/or alternatively perform other suitable processes. The error region determination module preferably performs polygon redetermination responsive to detection of an obstacle and/or new context (e.g., a significant change in path boundaries, etc.), and/or alternatively responsive to other trigger conditions.

The error can refer to the translational distance and/or angular differences between an objective (e.g., a planned path) and a current or future state of the vehicle. The error is preferably path-relative, but can alternatively be not path-relative. In an example, the error can include heading error (e_{ψ}) and/or lateral error (e_{y}). The error can add and/or alternatively include velocity error, heading rate error, and/or any other errors. In a first variant, the error region determination module can have an error space defined by a two-dimensional space, wherein the two-dimensional space can be defined by heading error on a first axis and lateral error on a second axis. The error space can alternatively be otherwise defined.

The error region determination module can perform calculation of a set of lateral error values as a function of heading error, and generation of convex polygons from a set of polygons fit to the set of lateral error values and heading error values. In a variant where the resulting set is nonconvex, the error region determination module can find an inner approximation convex polygon of the set (e.g., the largest convex polygon contained within the nonconvex set, etc.).

The error region determination module can perform event-triggered computations in which a safety set is characterized using convex polygons. In one variant, the error region determination module can output a convex polygon in error space (e.g., representing a safety region of operation of the vehicle, etc.). In a variant, the error region determination module can output a set of temporal polygons over a planning horizon, wherein each polygon in the set is associated with a relative time along the planning horizon. In a specific example, the edges of each convex polygon can be parameterized by vectors, and the number of vertices of each polygon can optionally vary over time (e.g., due to changes in obstacles and road boundaries).

However, the error region determination module 610 may be otherwise configured.

The constraint generator 620 functions to turn a convex polygon into a set of constraints for the MPC controller(s). The constraint generator preferably operates at each control timestep (e.g., each iteration of an MPC, etc.), but can alternatively operates responsive to other trigger conditions.

The constraint generator can transform polygon-based state constraints into Control Barrier Function (CBF) constraints (e.g., to address recursive feasibility issues inherent in the MPC with state constraints and facilitate forward invariance). In a variant, the constraint generator can generate multiple CBF constraints (e.g., 1st, 2nd, 3rd, and 4th-order CBF constraints, etc.) functioning as nested safety nets with increasing conservatism, allowing for smooth transitions between control actions as the vehicle approaches constraint boundaries.

In a specific example using the augmented lateral error state, the safety constraint can have relative degree 4 with respect to the control input.

The constraint generator can perform calculation of a set of constraints based on the convex polygon, and/or perform any other constraint generation processes.

The constraint generator can ingest a convex polygon, a set of vehicle parameters (e.g., a vehicle bounding box size, etc.), path boundary information (e.g., from the mapping module), a set of environmental parameters, and/or any other inputs. In a variant, the constraint generator can additionally ingest a set of temporal polygons over a planning horizon (e.g., output by the error region determination module, etc.) and a predicted mismatch value (e.g., from the mismatch prediction model, etc.).

In a variant, the constraint generator can use a lookahead time mechanism to map the set of temporal polygons to a set of safe sets over the control horizon. At each control timestep, for each step in the control horizon, the constraint generator can solve an optimization problem to find the closest temporal polygon with a trigger time not exceeding the projected time at that horizon step. The safe set at each horizon step can then be set to the polygon identified by the optimization. In this variant, the temporal polygons from the error region determination module (which are event-triggered and therefore unevenly spaced in time) can be mapped to a set of evenly-spaced safe sets required by the controller system 22 at each control timestep, and/or can be otherwise mapped.

The constraint generator can output constraints including a sequence of functions and/or a set of safety sets (e.g., from the polygon computation module, etc.), and/or any other constraints. In a variant, the constraint generator can output a set of safe sets over the control horizon (e.g., C_{k:k+N|k}, etc.).

However, the constraint generator 602 may be otherwise configured.

However, the safety function generator 600 may be otherwise configured.

However, the controller may be otherwise configured.

### 3.3 Vehicle Platform 30

The vehicle platform 30 functions to implement commands received from the MPC controller. The vehicle platform 30 can perform S600 and/or any other suitable processes. The vehicle platform 30 can include electronic control units (ECUs) that receive control signals from a set of MPC controllers. In variants, the vehicle platform can be a drive-by-wire system, a vehicle computing system, a CAN bus interface, and/or any other suitable platform. The vehicle platform 30 can be located onboard the vehicle and can communicatively connect to different vehicle subsystems (e.g., the braking subsystem, vehicle computing system, steering subsystem, etc.). In a first variant, the vehicle platform 30 can directly implement vehicle commands received from the MPC controller. In a second variant, the vehicle platform 30 can augment and/or transform data received from the MPC controller. The vehicle platform 30 system can calculate engine torque (Tₑ) and brake torque (T_{b}) from a vehicle command using vehicle mass, tire radius, tire stiffness values, transmission efficiency, gear ratios, and/or other suitable information. Additionally, the vehicle platform 30 can include a safety monitoring layer that validates control instructions against safety parameters (e.g., defined by the convex polygons, control barrier functions, and/or any other suitable safety parameters).

However, the vehicle platform 30 may be otherwise configured.

However, the system can include any other suitable components.

### 4. Method

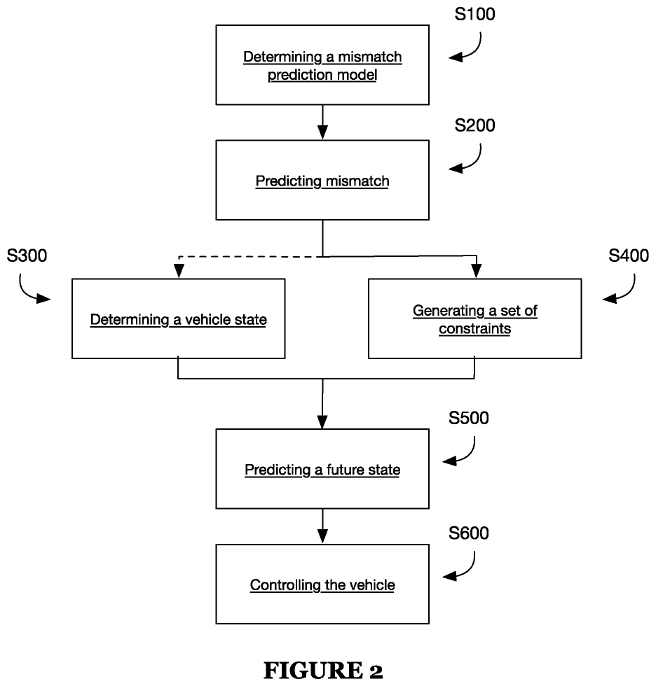

As shown in FIG. 2, the method can include: determining a mismatch prediction model S100; predicting mismatch S200; determining a vehicle state S300; generating a set of constraints S400; predicting a future state S500; and controlling the vehicle S600. The method functions to control an autonomous vehicle to track a planned trajectory.

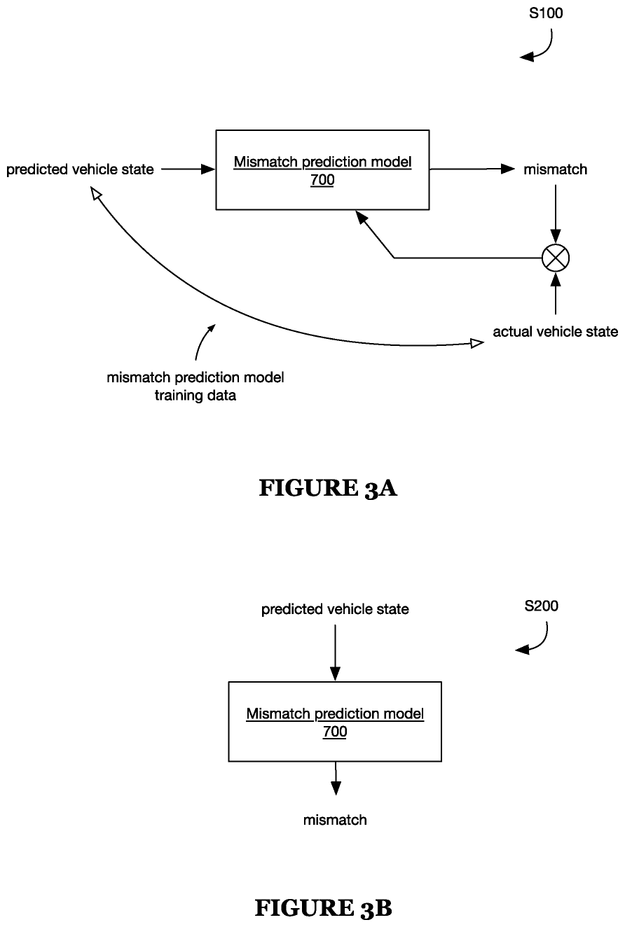

Determining a mismatch prediction model S100 functions to update the mismatch prediction model to incorporate most vehicle dynamics. S100 can include training, retraining, active learning, online updates, selection of a model based on context, and/or any other suitable type of model determination process. In an example, the mismatch prediction model is trained (e.g., example shown in FIG. 3A). S100 can be performed at a predetermined interval, at a dynamically-determined interval, responsive to a condition (e.g., detection of a new context, detection of a new obstacle, etc.) and/or responsive to any other information. S100 can be performed every 1 second, 0.5 seconds, 0.25 seconds, 0.1 seconds, but can alternatively be performed at another suitable interval. The interval between iterations of S100 can be different from a control interval (e.g., a predetermined multiple or fraction of a control interval), but can alternatively be the same as a control interval. In examples, the interval can be 2× the control interval, 4× the control interval, 5× the control interval, 10× the control interval, 25× the control interval, 100× the control interval, and/or any other multiple of the control interval.

S100 can use a set of training data collected during vehicle operation. Training inputs can include predicted state (e.g., from the vehicle dynamics model) for recent timesteps, and/or any other inputs. Training targets can include observed error, observed state (e.g., from the localization module) for recent timesteps, and/or any other timesteps, wherein each observed state corresponds to a predicted state from a same timestep. In a specific example, each training target can be computed as the deviation between the observed next state and the nominal predicted next state, transformed by a pseudo-inverse of a matrix defining the subspace of unknown dynamics. Each training input can be a feature vector comprising the current error state, a road banking angle, a rate of change of a

### Reference Heading, a Longitudinal Velocity, And/or Any Other Suitable Features.

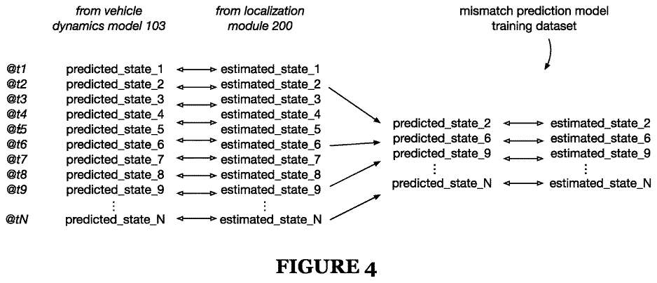

In a first variant, the training data can be the most recent X predicted/observed state pairs (e.g., where X can be 1, 5, 10, 50, 100, 1000, etc.). In a second variant, the training data can be a selected subset of the most recent X predicted state pairs. In this variant, the training data can be a non-sequential subset of the most recent X predicted state pairs (e.g., example shown in FIG. 4, etc.). In an example of this variant, the subset can be selected based on a set of filters. The filters can include a domain knowledge filter and/or an impact assessment filter. The domain knowledge filter can reject state pairs that lie outside of a set of predetermined state limits (e.g., to eliminate obvious outliers that could corrupt the GP model). The impact assessment filter can reject state pairs which have a high impact on the existing GP model (e.g., where the rejected state pair differs too much from training data used to train the existing mismatch prediction model). The impact assessment filter can prevent sudden, large changes to the mismatch prediction model to facilitate consistent control behavior. In an example, when a new data point satisfies the conditions of a set of filters, it replaces the oldest data point in a dictionary of predicted/observed state pairs.

In a specific example, the impact assessment filter can compare an existing prediction of the mismatch prediction model for a new input against the new observed measurement, and reject the new data point if the discrepancy exceeds a scaled confidence bound derived from the GP posterior uncertainty. In a variant, the impact assessment filter can be applied only once the training dataset has reached a threshold proportion of its maximum capacity (e.g., 80% or greater, etc.). In a variant, the training data dictionary can have a fixed maximum size, with new data replacing the oldest entry when capacity is reached.

However, determining a mismatch prediction model S100 may be otherwise performed.

Predicting mismatch S200 functions to predict the mismatch associated with vehicle dynamics model outputs (e.g., example shown in FIG. 3B).

S200 can be performed in different ways. In a first variant, S200 can be performed at each timestep (e.g., each time S500 is performed, for each set of measurements captured by the vehicle, etc.). In a second variant, S200 can be performed at predetermined or dynamic intervals, responsive to a trigger condition (e.g., encountering an obstacle, etc.), and/or at any other time. In a third variant, S200 can be performed responsive to the mismatch prediction model being retrained and/or updated. In a fourth variant, S200 can be performed each time a vehicle state is determined (e.g., using the localization module and/or MPC controller, etc.).

S200 can be performed by the mismatch prediction model, but can alternatively be performed by another suitable system component.

However, predicting mismatch S200 may be otherwise performed.

Determining a vehicle state S300 functions to estimate a kinematic state of the vehicle.

In a first variant, S300 can be performed by the localization module (e.g., wherein the current state is an estimated state based on actual measurements captured by the vehicle). In a second variant, S300 can be performed by the vehicle dynamics model (e.g., wherein the current state is a predicted state based on vehicle kinematics, etc.). In a third variant, S300 can use a state output from S500 in a prior timestep (e.g., where the vehicle current state is assumed to follow a prior control instruction exactly). In a fourth variant, S300 can be received at the controller from an upstream system in a planning/control pipeline (e.g., a localization module, etc.).

S300 is preferably performed at a predetermined interval (e.g., each time a new set of measurements is captured, etc.), but can alternatively be performed at a dynamic interval, and/or any other interval. In an example, S300 can be performed every 0.02 s, but can alternatively be performed at another suitable interval. The interval is preferably different from a control interval, but can alternatively not be different from the control interval.

However, determining a vehicle state s300 may be otherwise performed.

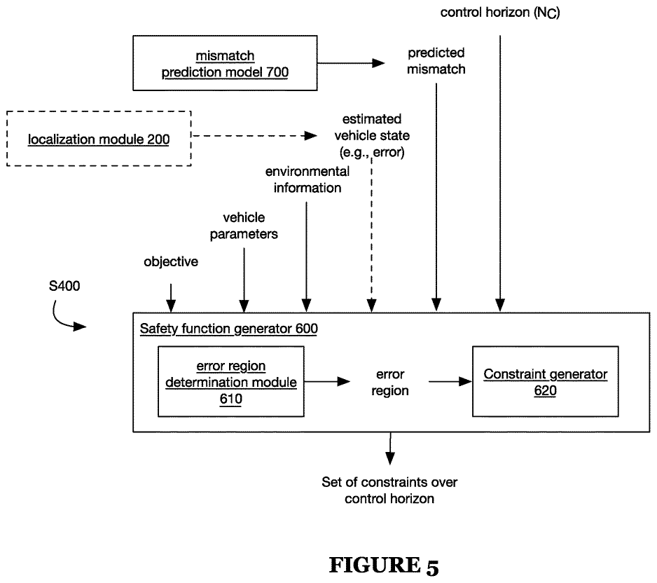

Generating a set of constraints S400 functions to update constraints used by the MPC controller (e.g., example shown in FIG. 5).

S400 is preferably performed by the safety function generator using methods described therein, but can additionally and/or alternatively be performed by another suitable system component.

S400 preferably performs polygon redetermination (e.g., by the polygon computation module, etc.) responsive to detection of an obstacle and/or new context, additionally and/or alternatively responsive to S200 being performed, and/or any other trigger conditions.

In an example, S400 can include redetermining polygons every time there is a significant change in path boundaries and/or when the vehicle encounters a new obstacle, and/or any other trigger.

S400 preferably performs constraint regeneration (e.g., by the constraint generator) at each control timestep (e.g., each iteration of S300 and/or S500, etc.), and can additionally and/or alternatively be performed responsive to S200 being performed, and/or any other trigger conditions.

S400 can include generating multiple constraints (e.g., the 1^{st}, 2^{nd}, 3^{rd}, and 4^{th}-order CBF constraints) functioning as nested safety nets with increasing conservatism, allowing for smooth transitions between control actions as the vehicle approaches constraint boundaries, and/or any other constraints.

In an example, S400 can include regenerating constraints at each control timestep (e.g., more frequently than polygon redetermination, etc.) and/or at any other frequency.

S400 preferably generates a control barrier function (CBF), but can alternatively generate any other suitable constraint.

However, generating a set of constraints S400 may be otherwise performed.

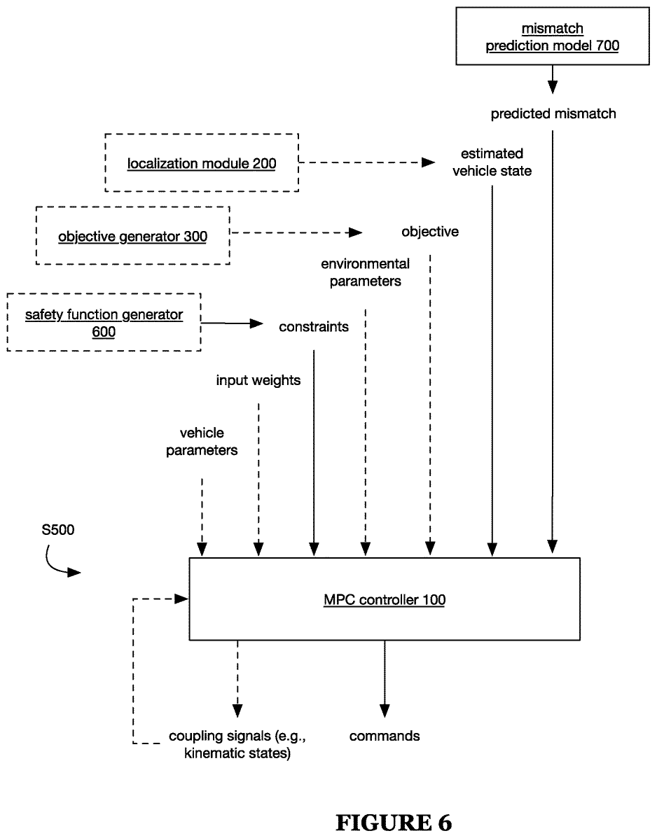

Predicting a future state S500 functions to determine a next state of the vehicle for vehicle controls (e.g., example shown in FIG. 6, and/or any other suitable vehicle controls). S500 can additionally function to determine a time series of future states over a control horizon (e.g., planned kinematic states at each timestep in the control horizon, etc.).

S500 can be performed iteratively (e.g., at a predetermined interval, responsive to capturing a new set of measurements, etc.), and/or any other performance schedule. S500 is preferably performed by a model predictive control module, but can additionally and/or alternatively be performed by any other suitable system component. In variants, S500 can include solving an optimization problem at each timestep in order to predict future states of the vehicle and/or determine vehicle controls therefrom. The optimization problem is preferably subject to the set of constraints from S400 (e.g., the mismatch-aware CBF constraints, etc.), but can alternatively be subject to any other suitable constraints or no constraints. S500 can use the current state generated in S300, the constraints generated in S400, and/or any other information. In an example, S500 can include identifying a most recently-determined set of constraints (e.g., determined when a trigger condition for performing S400 was most recently satisfied) and using the identified set of constraints. In variants, S500 can leverage the vehicle dynamics model to predict and/or evaluate potential future states of the vehicle during the optimization (e.g., using a bicycle model, etc.). In such variants, S500 can optionally correct future vehicle states predicted by the vehicle dynamics model using the predicted mismatch value from S200 (e.g., wherein the mismatch-corrected future states more accurately reflect the vehicle's actual behavior under unmodeled dynamics, varying environmental conditions, etc.). In an example, the vehicle dynamics model can correct the predicted error state using Equation 1, wherein the mean prediction from the Gaussian process is used to account for unmodeled dynamics.

In a specific example in which the controller system includes a longitudinal MPC controller and a lateral MPC controller, S500 can include first executing the longitudinal MPC controller to determine longitudinal vehicle commands and coupling signals (e.g., longitudinal velocity over the control horizon), and then executing the lateral MPC controller using the coupling signals from the longitudinal MPC controller, the predicted mismatch from S200, and the constraints from S400. In this variant, the lateral MPC controller can output lateral vehicle commands (e.g., a steering rate) and predicted lateral error states over the control horizon, and the lateral error states can in turn be converted back into coupling signals (e.g., lateral velocity and heading rate) for a subsequent iteration of the longitudinal MPC controller. In another specific example, S500 can include predicting a future state.

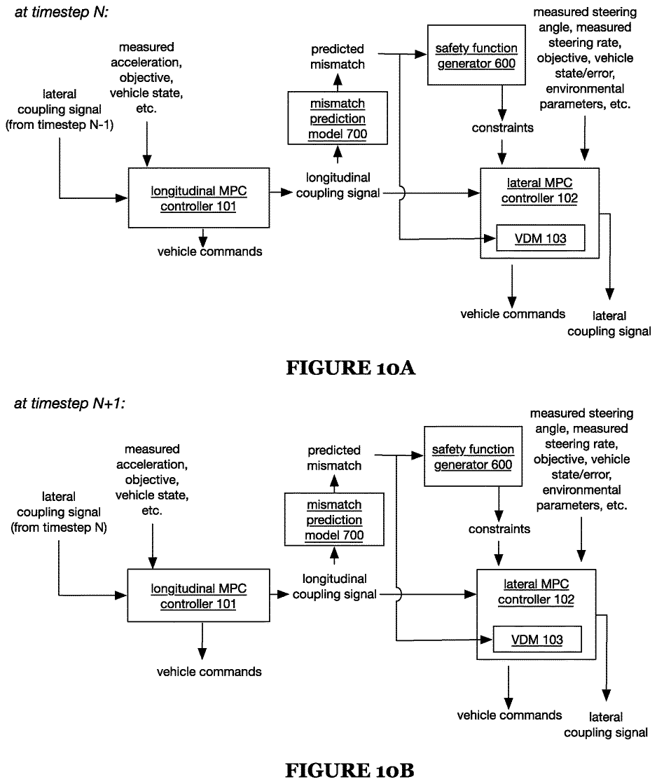

In an example, S500 can include executing the controller(s) according to the order as shown in FIGS. 10A-10B.

However, predicting a future state S500 may be otherwise performed.

S600 can include implementing a set of vehicle commands. The vehicle commands can be implemented directly (e.g., in variants where vehicle component commands are output directly from the controller system 22), can be converted into vehicle component commands before implementation (e.g., by transforming a vehicle command such as translational or rotational acceleration into a vehicle component command; such as a throttle torque command, or braking torque command, etc.), and/or used in any other suitable processes.

For variants in which the controller system 22 outputs a future state(s), the set of vehicle commands can be a future state (e.g., in variants where an MPC outputs direct controls, etc.), can be determined based on a future state (e.g., in variants where an MPC outputs kinematic states, such as acceleration, jerk, snap, crackle, etc.), and/or can be otherwise related to the future state.

In variants, S600 can include converting the vehicle commands into vehicle component commands. In such variants, converting vehicle commands into vehicle component commands can include converting longitudinal acceleration commands into engine torques, brake torques, throttle controls, motor speeds, and/or other vehicle commands using vehicle parameters including mass, tire radius, transmission efficiency, gear ratios, and maximum torque limits; converting lateral MPC controller outputs (e.g., angular rotation commands, lateral translation commands, etc.) into steering column component commands such as steering angle commands, steering rate commands, steering motor torque commands, electric power steering system commands, hydraulic steering pressure commands, and/or other steering actuator control signals using vehicle parameters including steering gear ratios, steering system dynamics parameters, motor specifications, and actuator response characteristics; and/or transforming error-space lateral outputs into absolute state values for integration with longitudinal control coupling signals. In examples of such variants, conversion of vehicle commands into vehicle component commands can be performed within each MPC controller or downstream of each MPC controller (e.g., as a post-processing step).

S600 is preferably performed responsive to S500 (e.g., in real-time), but can additionally and/or alternatively be performed at any other time. S600 is preferably performed by the drive-by-wire system, but can additionally and/or alternatively be performed by the vehicle computing system and/or any suitable subcomponent thereof. S600 can include converting the future state from S500 into a set of vehicle component commands (e.g., torque commands, braking commands, steering commands) and executing the commands. In an example, S600 can include executing the set of vehicle component commands.

In variants, S600 can include controlling a steering system (e.g., an electric and/or hydraulic power steering actuator, etc.), a drive system (e.g., including a set of brakes, a fuel injector, an engine, a transmission, etc.), and/or any suitable vehicle components. In an example, S600 includes sending a command to an ECU of any of the aforementioned systems and executing the command at the ECU. In examples, S600 can include actuating any of the aforementioned vehicle components (e.g., applying the brakes, opening a throttle valve, applying a steering torque at a steering gearbox, etc.). In examples, the lateral MPC controller can determine vehicle commands for the steering system, and the longitudinal MPC controller can be used to determine vehicle commands for the drive system. In a specific example, vehicle commands from each MPC can be non-overlapping (e.g., where each MPC facilitates vehicle command determination for one of the longitudinal and lateral MPC). In this specific example, the constraints or a subset thereof (e.g., CBF constraints, etc.) can be used to determine vehicle commands for only one of the vehicle drive system or vehicle steering system (e.g., the lateral MPC controller only, etc.)at components of an autonomous vehicle (e.g., a steering system, braking system, throttle control system, transmission control system, engine control module (ecm), etc.).

However, controlling the vehicle S600 may be otherwise performed.

The method can be performed during a driving session of an autonomous vehicle and/or at any other suitable time. All or portions of the method can be performed in real time (e.g., responsive to a request), iteratively, concurrently, asynchronously, periodically, and/or at any other suitable time. All or portions of the method can be performed automatically, manually, semi-automatically, and/or otherwise performed.

All or portions of the method can be performed by one or more components of the system, using a computing system, using a database (e.g., a system database, a third-party database, etc.), by a user, and/or by any other suitable system. The computing system can include one or more: CPUs, GPUs, custom FPGA/ASICS, microprocessors, servers, cloud computing, and/or any other suitable components. The computing system can be local, remote, distributed, or otherwise arranged relative to any other system or module.

Different subsystems and/or modules discussed above can be operated and controlled by the same or different entities. In the latter variants, different subsystems can communicate via: APIs (e.g., using API requests and responses, API keys, etc.), requests, and/or other communication channels.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the following system and/or method can be used with, in addition to, in lieu of, or otherwise integrated with all or a portion of the systems and/or methods disclosed in the applications mentioned above, each of which are incorporated in their entirety by this reference.

As a person skilled in the art will recognize from the previous detailed description and from the figures and claims, modifications and changes can be made to the preferred embodiments of the invention without departing from the scope of this invention defined in the following claims.

We claim:

1. A method for a vehicle, comprising:
using at least a sensor, collecting a set of vehicle state measurements;
based on the set of vehicle state measurements, determining a set of vehicle state parameters;
based on the set of vehicle state parameters:
determining a first vehicle state prediction using a vehicle dynamics model; and
using a learned model, determining a predicted mismatch between the first vehicle state prediction and a future vehicle state;
determining a set of constraints for a controller based on the predicted mismatch; and
determining a second vehicle state prediction by aggregating the first vehicle state prediction and the predicted mismatch; and
based on the second vehicle state prediction, controlling the vehicle according to the set of constraints using the controller.

2. The method of claim 1, wherein the controller determines vehicle commands based on the second vehicle state prediction and the set of constraints.

3. The method of claim 1, wherein the controller is a lateral controller configured to determine lateral vehicle commands, and wherein the method further comprises, using a longitudinal controller, determining longitudinal commands independently of the predicted mismatch.

4. The method of claim 1, wherein the set of constraints comprises a control barrier function (CBF).

5. The method of claim 4, wherein the CBF is 4th-order control barrier function based on a lateral kinematic error of the vehicle.

6. The method of claim 4, wherein determining the set of constraints comprises:
determining a set of regions in a vehicle kinematic error space; and
transforming the set of regions into the CBF, wherein the controller determines vehicle commands based on the CBF.

7. The method of claim 6, wherein a number of sides of a region of the set of regions is dynamically-determined during vehicle operation.

8. The method of claim 1, wherein the learned model comprises a Gaussian Process (GP).

9. The method of claim 1, wherein the predicted mismatch comprises a point estimate of mismatch between the vehicle state prediction and the future vehicle state.

10. The method of claim 1, wherein the controller comprises a model predictive controller (MPC).

11. The method of claim 1, further comprising:
based on a subsequent set of vehicle state measurements, determining a subsequent vehicle state;
based on a comparison between the subsequent vehicle state and the second vehicle state prediction, determining an observed mismatch; and
updating the learned model based on the observed mismatch.

12. The method of claim 11, wherein updating the learned model is performed responsive to the observed mismatch satisfying a threshold.

13. The method of claim 12, wherein the threshold is based on an uncertainty estimate determined by the learned model.

14. The method of claim 11, wherein updating the learned model is performed at a different interval than a control interval of the controller, wherein the controller determines vehicle commands at the control interval.

15. The method of claim 1, wherein the vehicle is an articulated vehicle comprising a plurality of coupled bodies, and wherein the predicted mismatch corresponds to vehicle dynamics interactions between the plurality of coupled bodies.

16. A method for an autonomous vehicle, comprising:
using a first controller, determining a first kinematic state estimate in a first dimension;
collecting a set of vehicle state measurements;
based on the set of vehicle state measurements, using a vehicle dynamics model, determining a first vehicle state prediction;
based on the first kinematic state estimate, determining an error prediction for the first vehicle state prediction, wherein the error prediction is in a second dimension distinct from the first dimension;
determining a second vehicle state prediction based on the first vehicle state prediction and based on the error prediction;
using the second controller, controlling the vehicle based on the second vehicle state prediction.

17. The method of claim 16, wherein the first dimension is longitudinal and the second dimension is lateral.

18. The method of claim 17, wherein controlling the vehicle based on the second vehicle state prediction comprises determining a set of lateral commands subject to a set of constraints determined based on the second vehicle state prediction, wherein, in an iteration of a vehicle control cycle, the first controller determines a set of longitudinal commands before the set of constraints is determined.

19. The method of claim 16, wherein the error prediction accounts for at least two parameters selected from a set consisting of: tire-road interactions, mass distribution changes, aerodynamic forces, actuator dynamics, and sensor calibration effects.

20. The method of claim 1, wherein determining the first kinematic state estimate is performed before collecting the set of vehicle state measurements.
